(19) United States
(12) Patent Application Publication
(10) Pub. No.: US 2012/0084240 A1
(43) Pub. Date: Apr. 5, 2012

(54) PHASE CHANGE MEMORY SYNAPTRONIC CIRCUIT FOR SPIKING COMPUTATION, ASSOCIATION AND RECALL

(75) Inventors: Steven K. Esser, San Jose, CA (US); Dharmendra S. Modha, San Jose, CA (US); Anthony Ndirango, Berkeley, CA (US); Bipin Rajendran, White Plains, NY (US)

(73) Assignee: International Business Machines Corporation, Armonk, NY (US)

(21) Appl. No.: 12/895,710

(22) Filed: Sep. 30, 2010

(51) Int. Cl. G06N 3/04

(52) U.S. Cl. 706/27

(57) ABSTRACT

Embodiments of the invention are directed to producing spike-timing dependent plasticity using electronic neurons for computation, and pattern matching tasks such as association and recall. In response to an electronic neuron spiking, a spiking signal is sent from the electronic neuron to each axon driver and each dendrite driver connected to the spiking electronic neuron. Each axon driver receiving the spiking signal sends an axonal signal from the axon driver to a variable state resistor. Each dendrite driver receiving the spiking signal sends a dendritic signal from the dendrite driver to the variable state resistor, wherein the variable state resistor couples the axon driver and the dendrite driver. The combination of the axonal and dendritic signals is capable of increasing or decreasing conductance of the variable state resistor.

This invention was made with United States Government support under Agreement No. HR0011-09-C-0002 awarded by Defense Advanced Research Projects Agency (DARPA). The Government has certain rights in the invention.

### BACKGROUND

The present invention relates generally to neuromorphic systems, and more specifically to neuromorphic systems based on phase change memory (PCM) synapses.

Biological systems impose order on the information provided by their sensory input. This information typically comes in the form of spatiotemporal patterns comprising localized events with a distinctive spatial and temporal structure. These events occur on a wide variety of spatial and temporal scales, and yet a biological system such as the brain is still able to integrate them and extract relevant pieces of information. Such biological systems can rapidly extract signals from noisy spatiotemporal inputs.

In biological systems, the point of contact between an axon of a neuron and a dendrite on another neuron is called a synapse, and with respect to the synapse, the two neurons are respectively called pre-synaptic and post-synaptic. The essence of our individual experiences is stored in the conductance of the synapses. The synaptic conductance can change with time as a function of the relative spike times of pre-synaptic and post-synaptic neurons, as per spike-timing dependent plasticity (STDP). The STDP rule increases the conductance of a synapse if its post-synaptic neuron fires after its pre-synaptic neuron fires, and decreases the conductance of a synapse if the order of the two firings is reversed.

Neuromorphic systems, also referred to as artificial neural networks, are computational systems that permit electronic systems to essentially function in a manner analogous to that of biological brains. Neuromorphic systems do not generally utilize the traditional digital model of manipulating 0s and 1s. Instead, neuromorphic systems create connections between processing elements that are roughly functionally equivalent to neurons of a biological brain. Neuromorphic systems may comprise various electronic circuits that are modeled on biological neurons.

### BRIEF SUMMARY

Embodiments of the invention provide an architecture and method to realize an electronic implementation of spiking neurons interacting with each other via programmable, plastic synapses for computation, and pattern matching tasks such as association and recall. An aspect of the invention includes a method for producing spike-timing dependent plasticity using electronic neurons. In response to an electronic neuron spiking, a spiking signal is sent from the electronic neuron to each driver circuit connected to the axon and dendrite wires (called axon driver and each dendrite driver) connected to the spiking electronic neuron. Each axon driver receiving the spiking signal sends an axonal signal from the axon driver to a variable state resistor. Each dendrite driver receiving the spiking signal sends a dendritic signal from the dendrite driver to the variable state resistor, wherein the variable state resistor couples the axon driver and the dendrite driver. The combination of the axonal and dendritic signals is capable of increasing or decreasing conductance of the variable state resistor.

Another aspect of the invention includes a system for producing spike-timing dependent plasticity. The system comprises a plurality of electronic neurons and a cross-bar array coupled to the plurality of electronic neurons and configured to interconnect the plurality of electronic neurons. The cross-bar array comprises a plurality of axons and a plurality of dendrites such that the axons and dendrites are orthogonal to one another. The cross-bar array further comprises plural variable state resistors, such that each variable state resistor is at a cross-point junction of the cross-bar array coupled between a dendrite and an axon. The cross-bar array further comprises a plurality of dendrite drivers corresponding to the plurality of dendrites, each dendrite driver coupled to a dendrite at a first side of the cross-bar array. The cross-bar array further comprises a plurality of axon drivers corresponding to the plurality of axons, each axon driver coupled to an axon at a second side of the cross-bar array. Wherein an axon driver and a dendrite driver coupled by a variable state resistor at a cross-point junction are configured to generate signals which in combination are capable of changing the state of the variable state resistors as a function of time since a last spiking of an electronic neuron firing a spiking signal into the axon driver and the dendrite driver.

Another aspect of the invention includes a neuromorphic system comprising a plurality of electronic neurons having a layered relationship with directional connectivity. The system further comprises a first excitatory spiking electronic neuron layer comprising first excitatory spiking electronic neurons, and a second excitatory spiking electronic neuron layer comprising second excitatory spiking electronic neurons. The system further comprises a first inhibitory spiking electronic neuron layer comprising one or more first inhibitory spiking electronic neurons. Wherein the first excitatory spiking electronic neuron layer is configured to receive input, and wherein the first and second excitatory spiking electronic neuron layers and the first inhibitory spiking electronic neuron layer, are configured to process the received input based on learning rules. Each of the first excitatory spiking electronic neuron layer and first excitatory spiking electronic neuron layer comprises a system for producing spike-timing dependent plasticity including a cross-bar array mentioned above.

These and other features, aspects and advantages of the present invention will become understood with reference to the following description, appended claims and accompanying figures.

### BRIEF DESCRIPTION OF THE SEVERAL VIEWS OF THE DRAWINGS

FIG. 1 shows a diagram of a Phase Change Memory (PCM) synaptronic cross-bar array circuit for spiking computation, in accordance with an embodiment of the invention;

FIG. 2 shows a diagram of an implementation of the synaptronic circuit of FIG. 1, in accordance with an embodiment of the invention;

FIG. 3A shows a diagram of axon interface drivers for the synaptronic circuit of FIG. 1, in accordance with an embodiment of the invention;

FIG. 3B shows a diagram and signal timing for the axon interface drivers of FIG. 3A, in accordance with an embodiment of the invention;

FIG. 4A shows a diagram of dendrite interface drivers for the synaptronic circuit of FIG. 1, in accordance with an embodiment of the invention;

FIG. 4B shows a diagram and signal timing for the dendrite interface drivers of FIG. 4A, in accordance with an embodiment of the invention;

FIG. 4C shows a diagram of a level interface driver, in accordance with an embodiment of the invention;

FIG. 5A shows a diagram of a layered architecture of a spiking neuron circuit for spatiotemporal associative memory, in accordance with another embodiment of the invention;

FIG. 5B shows a diagram of an implementation of the layered architecture of FIG. 5A, using synaptronic cross-bar array circuit, in accordance with another embodiment of the invention; and

FIG. 6 shows a high level block diagram of an information processing system useful for implementing one embodiment of the present invention.

### DETAILED DESCRIPTION

Embodiments of the invention provide neuromorphic systems, including Phase Change Memory (PCM) synaptronic circuits for spiking computation, association and recall. In one embodiment, the present invention provides a synaptronic circuit architecture and operating method.

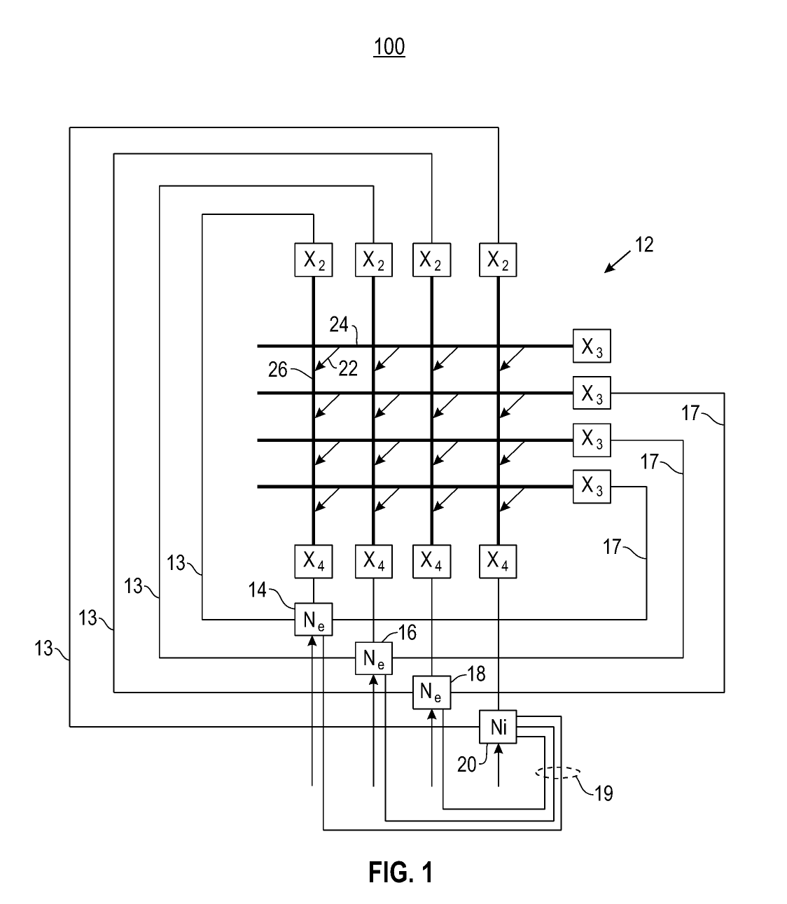

In one embodiment, the synaptronic circuit comprises a synapse cross-bar array which implements spike-timing dependent plasticity (STDP) using PCM synapse devices. Embodiments include analog variable state resistor which implement amplitude modulated STDP versions and binary variable state resistor which implement probability modulated STDP versions. Disclosed embodiments include systems with access devices and systems without access devices. Referring now to FIG. 1, there is shown a diagram of a neuromorphic system 100 comprising a cross-bar array 12 having a plurality of neurons 14, 16, 18 and 20 as a network. These neurons are also referred to herein as “electronic neurons.” In one example, the cross-bar array may have a pitch in the range of about 0.1 nm to 10 μm.

The system 100 further comprises synapse devices 22 including variable state resistors at the cross-point junctions of the cross-bar array 12, wherein the synapse devices 22 are connected between axons 24 and dendrites 26 such that the axons 24 and dendrites 26 are orthogonal to one another. The term variable state resistor refers to a class of devices in which the application of an electrical pulse (either a voltage or a current) will change the electrical conductance characteristics of the device. For a general discussion of cross-bar array neuromorphic systems as well as to variable state resistors as used in such cross-bar arrays, reference is made to K. Likharev, “Hybrid CMOS/Nanoelectronic Circuits: Opportunities and Challenges”, J. Nanoelectronics and Optoelectronics, 2008, Vol. 3, p. 203-230, which is hereby incorporated by reference. In one embodiment of the invention, the variable state resistor may comprise a PCM synapse device. Besides PCM devices, other variable state resistor devices that may be used in embodiments of the invention include devices made using metal oxides, sulphides, silicon oxide and amorphous silicon, magnetic tunnel junctions, floating gate FET transistors, and organic thin film layer devices, as described in more detail in the above-referenced article by K. Likharev. The variable state resistor may also be constructed using a static random access memory device.

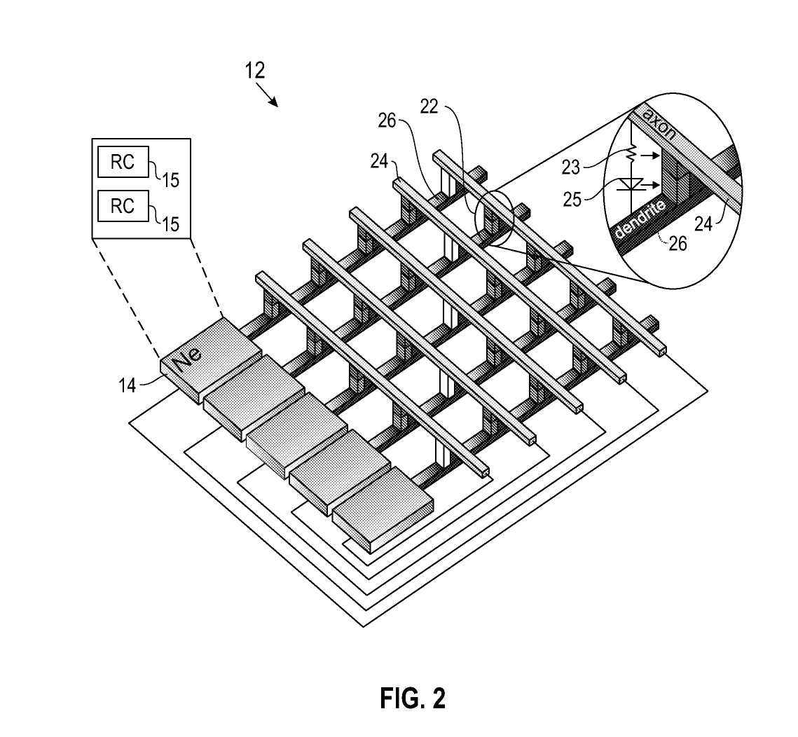

FIG. 2 shows an example implementation of the cross-bar array 12, wherein each synapse device 22 comprises a variable state resistor 23 as a programmable resistor. The cross-bar array 12 comprises a nano-scale cross-bar array comprising said resistors 23 at the cross-point junctions, employed to implement arbitrary and plastic connectivity between said electronic neurons. An access or control device 25 such as a PN diode or an FET wired as a diode (or some other element with a nonlinear voltage-current response), may be connected in series with the resistor 23 at every cross-bar junction to prevent cross-talk during signal communication (neuronal firing events) and to minimize leakage and power consumption; however this is not a necessary condition to achieve synaptic functionality.

Each electronic neuron comprises a pair of RC circuits 15. In general, in accordance with an embodiment of the invention, neurons “fire” (transmit a pulse) in response to the integrated inputs they receive from dendritic input connections 26 exceeding a threshold. When neurons fire, they maintain an anti-STDP (A-STDP) variable that decays with a relatively long, predetermined, time constant determined by the values of the resistor and capacitor in one of its RC circuits. For example, in one embodiment, this time constant may be about 50 ms. The A-STDP variable may be sampled by determining the voltage across the capacitor using a current mirror, or equivalent circuit. This variable is used to achieve axonal STDP, by encoding the time since the last firing of the associated neuron. Axonal STDP is used to control “potentiation”, which in this context is defined as increasing synaptic conductance. When neurons fire, they also maintain a D-STDP variable that decays with a relatively long, predetermined, time constant based on the values of the resistor and capacitor in one of its RC circuits 15. As used herein, the phrase “in response to” or the term “when” can mean that a signal is sent instantaneously after a neuron fires, or some period of time after the neuron fires.

As shown in FIG. 1, the electronic neurons 14, 16, 18 and 20 are configured as circuits at the periphery of the cross-bar array 12. In addition to being simple to design and fabricate, the cross-bar architecture provides efficient use of the available space. Complete neuron connectivity inherent to the full cross-bar array can be converted to any arbitrary connectivity by electrical initialization or omitting mask steps at undesired locations during fabrication. The cross-bar array 12 can be configured to customize communication between the neurons (e.g., a neuron never communicates with another neuron). Arbitrary connections can be obtained by blocking certain synapses at fabrication level. Therefore, the architectural principle of the system 100 can mimic all the direct wiring combinations observed in biological neuromorphic networks.

The cross-bar array 12 further includes driver devices X₂, X₃ and X₄ as shown in FIG. 1 (the driver devices are not shown in FIG. 2 for clarity). The devices X₂, X₃ and X₄ comprise interface driver devices. Specifically, the dendrites 26 have driver devices X₂ on one side of the cross-bar array 12 and sense amplifiers X₄ on the other side of the cross-bar array. The axons 24 have driver devices X₃ on one side of the cross-bar array. The diver devices comprise CMOS logic circuits implementing the functions described herein.

The sense amplifier devices X₄ feed into excitatory spiking electronic neurons (Nₑ) 14, 16 and 18, which in turn connect into the axon driver devices X₃ and dendrite driver devices X₂. The neuron 20 is an inhibitory spiking electronic neuron (Nᵢ). Generally, an excitatory spiking electronic neuron makes its target neurons more likely to fire, while an inhibitory spiking electronic neuron makes its targets less likely to fire. A variety of implementations of spiking electronic neurons can be utilized. Generally, such neurons comprise a counter that increases when inputs from source excitatory neurons are received and decreases when inputs from source inhibitory neurons are received. The amount of the increase or decrease is dependent on the strength of the connection from a source neuron to a target neuron. If the counter reaches a certain threshold, the neuron then generates its own spike (i.e., fires) and the counter undergoes a reset to a baseline value. The term spiking electronic neuron is referred to as “electronic neuron” herein.

In this example, each of the excitatory neurons 14, 16, 18 (Nₑ) is configured to provide integration and firing. Each inhibitory neuron 20 (Nᵢ) is configured to regulate the activity of the excitatory neurons depending on overall network activity. As those skilled in the art will recognize, the exact number of excitatory neurons and inhibitory neurons can vary depending on the nature of the problem to solve using the disclosed architecture herein.

A read spike of a short duration (e.g., about 0.05 ms to 0.15 ms and preferably about 0.1 ms long) may be applied to an axon driver device X₃ for communication. An elongated pulse (e.g., about 150 ms to 250 ms and preferably about 200 ms long) may be applied to the axon driver device X₃ and a short negative pulse may be applied to the dendrite driver device X₂ midway through the axon driver pulse (e.g., about 45 ns to 55 ns and preferably about 45 ns long) for programming. As such, the axon driver device X₃ provides a long programming pulse and communication spikes. A dendrite driver device X₂ provides a programming pulse with a delay. In one embodiment of the invention where a neuron circuit is implemented using analog logic circuits, a corresponding sense amplifier X₄ translates PCM current levels to neuron current levels for integration. In another embodiment of the invention where a neuron circuit is implemented using digital logic circuits, a corresponding sense amplifier X₄ translates PCM current levels to binary digital signals for integration.

In FIGS. 1 and 2, the synapse devices 22 including resistors 23, implement synapses with spike-timing based learning. The network represented by the cross-bar array 12 can be used in implementing networks with learning rules. When a neuron spikes, it sends spike signals to interface drivers X₂ and X₃.

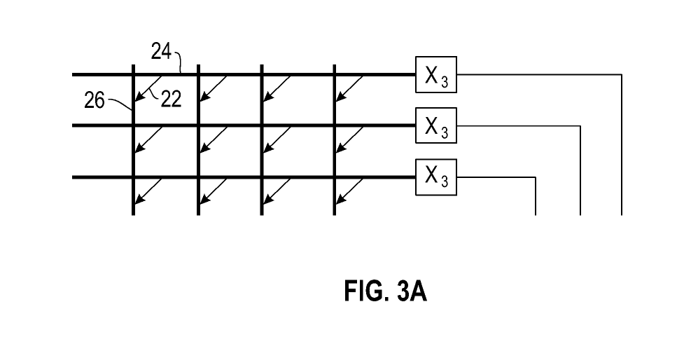

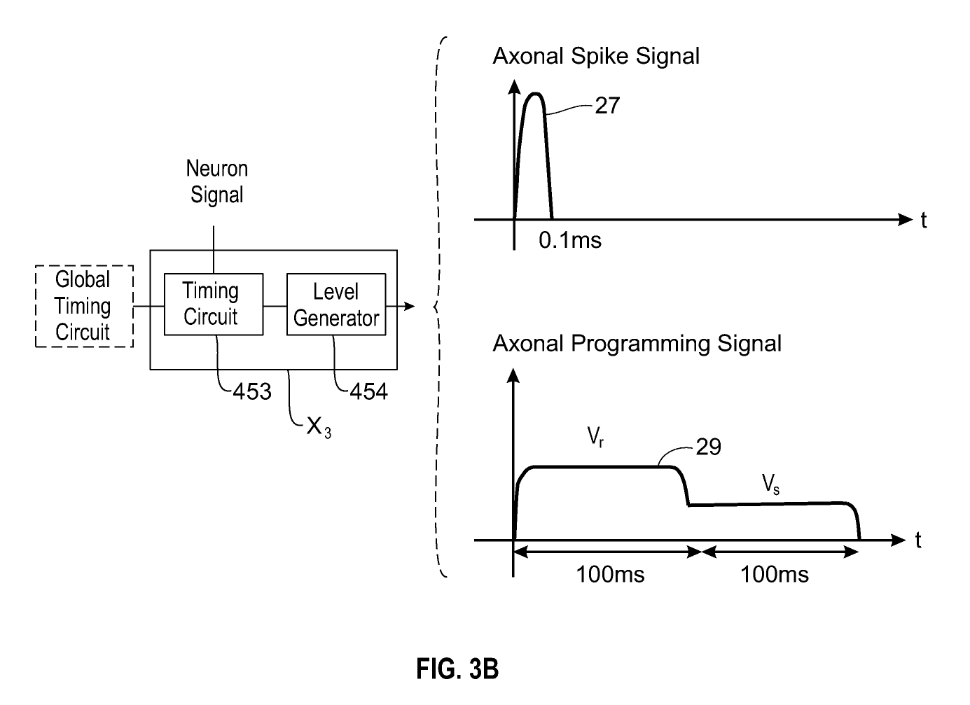

FIG. 3A shows the axon interface drivers X₃ in the example cross-bar array of FIG. 1. When an interface driver X₃ receives a spike signal from a neuron, the interface driver X₃ generate axonal signals. As shown by example in FIG. 3B, in one embodiment, an axon driver X₃ comprises a timing circuit 453 and a level generator circuit 454. When the driver X₃ receives a spike signal from a neuron, the level generator circuit 454 of the driver X₃ generates axonal signals. FIG. 3B shows an example of the axonal signals, wherein a first signal 27 comprises a pulse (e.g., about 0.05 ms to 0.15 ms and preferably about 0.1 ms long) and is typically used for forward communication of the neuron spike signal. The spike signal from a neuron creates a voltage bias across a connecting synaptic device 22, resulting in a current flow into down-stream neurons, such that the magnitude of the current is weighted by the conductance of the synaptic device 22. A subsequent second signal 29 comprises a pulse (e.g., about 150 ms to 250 ms and preferably about 200 ms long) and is used for implementing programming of the resistor 23 at the cross-bar array junction for interface drivers X₂ and X₃. The second signal functions to increase or decrease conductance of a variable state resistor at a cross-point junction coupling the axon driver and the dendrite driver, as a function of time since a last spiking of the electronic neuron firing a spiking signal into the axon driver and the dendrite driver.

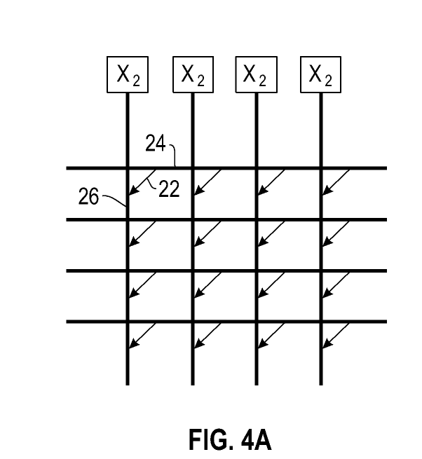

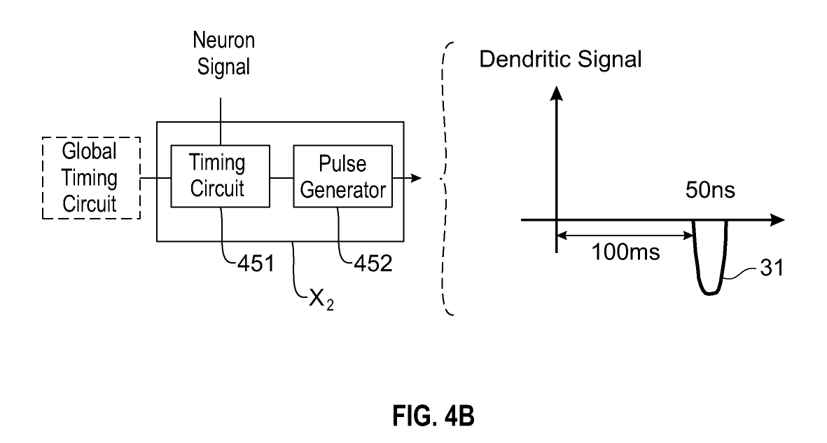

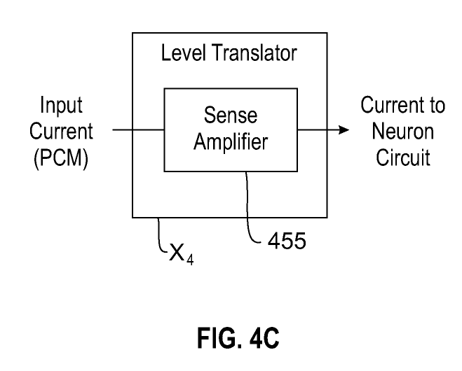

FIG. 4A shows the dendrite drivers X₂ in the example cross-bar array of FIG. 1. When a dendrite driver X₂ receives a spike signal from a neuron, in one example shown in FIG. 4B, after a delay (e.g., about 50 ms to 150 ms and preferably about 100 ms long) the interface driver X₂ generates a dendritic spike signal (e.g., about 45 ns to 55 ns and preferably about 50 ns long). As shown by example in FIG. 4B, in one embodiment, the dendrite driver X₂ comprises a timing circuit 451 and a pulse generator circuit 452. Upon receiving a spike from a neuron, at the end of a delay period, the pulse generator circuit 452 generates a dendritic spike signal about 50 ns long.

In general, the combined action of the signals from drivers X₂ and X₃ in response to spiking signals from the firing neurons in the cross-bar array 12, causes the corresponding resistors 23 in synapses 22 at the cross-bar array junctions thereof, to change value based on the spiking timing action of the firing neurons. This provides programming of the resistors 23. Referring to FIGS. 3A and 4A, the magnitude of the voltage pulses generated by interface drivers X₂ and X₃ are selected such that the current flow through the connected synaptic device 22 due to the activity of only one among the interface drivers X₂ and X₃ is insufficient to program the synaptic device 22.

In an analog implementation of a neuron, each level translator device X₄ comprises a circuit configured to translate the amount of current from each corresponding synapse 22 for integration by the corresponding neuron. As shown by example in FIG. 4C, for a digital implementation of a neuron, in one embodiment a level translator device X₄ comprises a sense amplifier 455 for accomplishing the same function. In one example, each level translator device X₄ translates PCM currents wherein a PCM ON current of about 10 μA is translated to about 10 nA, and a PCM OFF current of about 100 nA is translated to about 100 pA. Further, level translators X₄ prevent integration of programming current by blocking any current flow in a neuron when a corresponding driver X₂ is active.

The timing in delivering signals from the neurons in the cross-bar array 12 to the devices X₂, X₃, X₄, and the timing of the devices X₂, X₃, X₄ in generating signals, allows programming of the synapses. One implementation comprises changing the state of a resistor 23 by increasing or decreasing conductance of the resistor 23 as a function of time since a last spiking of an electronic neuron firing a spiking signal into the axon driver and the dendrite driver coupled by the resistor 23. In general, neurons generate spike signals and the devices X₂, X₃, X₄ interpret the spikes signals, and in response generate signals described above for programming the synapses 22. The synapses and neurons can be analog or digital. The example signals in FIGS. 3B and 4B are shown for an analog synapses made from PCM devices.

FIG. 3B shows a read spike 27 of a short duration (e.g., about 0.05 ms to 0.15 ms and preferably about 0.1 ms long) generated by the axon driver device X₃ for communication as soon as it receives the spiking signal from the associated neuron. An elongated pulse 29 (e.g., about 150 ms to 250 ms and preferably about 200 ms long) is generated by the axon driver device X₃ as soon as it receives the spiking signal from the associated neuron. As shown in FIG. 4B, a short negative pulse 31 (e.g., about 45 ns to 55 ns and preferably about 45 ns long) is generated by the dendrite driver device X₂ about after a period (e.g., about 50 ms to 150 ms and preferably about 100 ms long) has elapsed since it receives the spiking signal from the associated neuron (FIG. 3B) for programming the synapses 22. As such, the axon driver device X₃ provides a long programming pulse 29 and communication spikes 27.

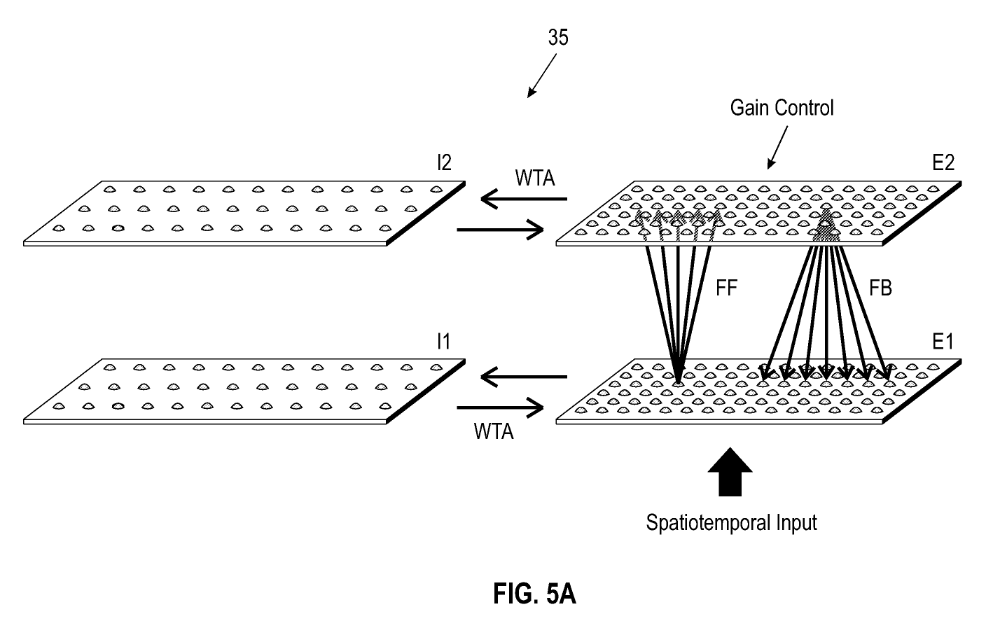

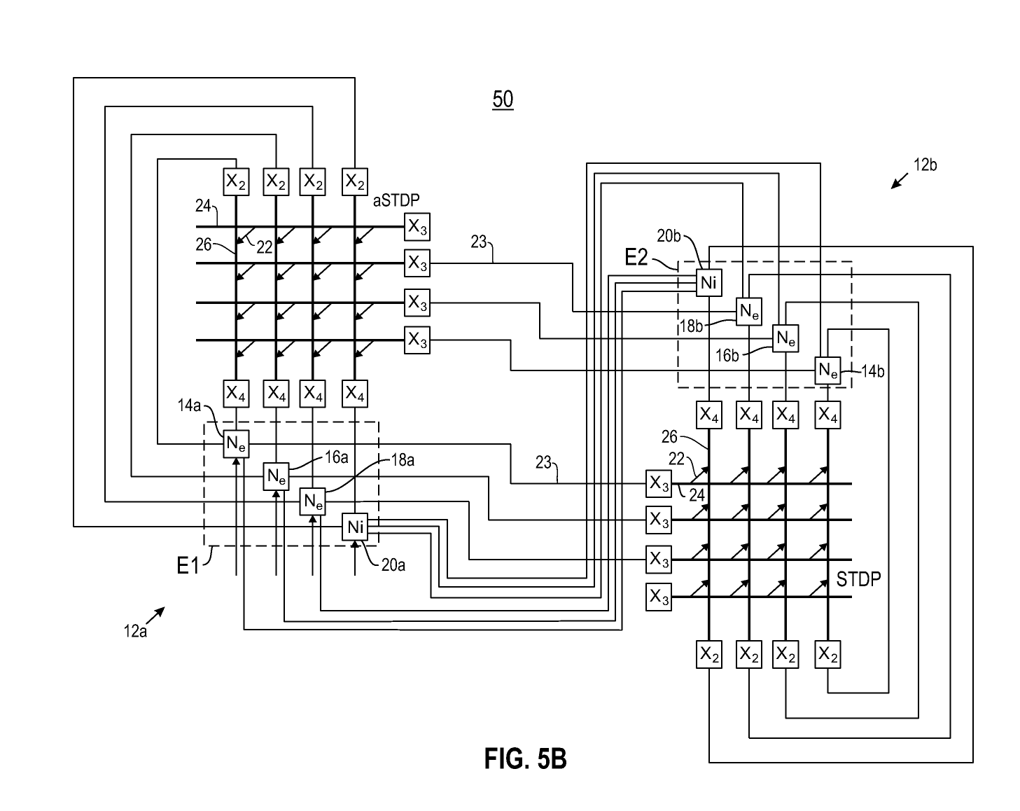

The system 100 serves as the basic building block to generate any spiking network of integrate-and-fire neurons interacting through plastic synapses. Other schemes to achieve STDP can also be used with the architecture of system 100. FIG. 5A shows an example application of the architecture 100 of FIG. 1, a layered architecture 35 with directional connectivity that uses spiking computation for associative recall, according to another embodiment of the invention. The layered architecture 35 includes neurons in layers, with connections and learning rules between them.

One embodiment of the architecture 35 comprises a spiking electronic neuron microcircuit implementing an unsupervised pattern recognition system of the associative recall type. A pattern recognition system comprises an assembly of interacting spiking electronic neurons in a memory microcircuit configured to store and associatively recall spatiotemporal patterns. Learning rules provide the strengths (i.e., level of conductance) of synaptic interconnections between the electronic neurons as a function of the patterns to be stored.

According to an embodiment of the invention, given an input data stream that contains spatiotemporal patterns, the architecture 35 learns to detect the presence of the patterns, and to extract and store the patterns without requiring that any information about the patterns to be detected be provided ahead of time. The system stores the patterns in such a way that when presented with a fragmentary and/or noisy version of the stored pattern, the system is able to retrieve a proper matching pattern from memory.

In addition to the spatiotemporal patterns, the input data stream may in general contain a level of noise. The pattern recognition system carries out pattern recognition in a real-time or online fashion, and does not require separate stages for processing the incoming information. The system processes the incoming information in real-time as the data stream is fed in to the system. In an embodiment of the invention, the system architecture is modular and scalable, suitable for problems of a combinatorial nature on multiple spatial and temporal scales while using a single, streamlined architecture.

The architecture 35 comprising two layers E1 and E2 of excitatory electronic neurons. The system 100 further comprises two layers I1 and I2 of inhibitory electronic neurons. The architecture 35 provides directional connectivity between the neurons (feedforward and feedback), implementing interplay of a winner-take-all (WTA) process via lateral inhibition and spike driven learning rules which serve to select causal associations between events. The E1 layer receives spatio-temporal inputs (e.g., images of circles or squares with temporal variations in appearance). Patterns presented to the E1 layer lead to compressed representations on the E2 layer. Partial or corrupted versions of previously encountered patterns lead to error-free retrieval of complete versions.

In one example, a random distribution of weights is utilized, such that each E2 neuron needs input from about 10% of E1 neurons, in order to spike. The feed forward (FF) connections exhibit STDP, wherein inputs leading to significant spatiotemporal correlations in E1 layer neuronal activity cause certain E2 layer neurons to fire. The 12 layer ensures that the activity in the E2 layer is limited to a very small number. If E1 layer neurons fire before E2 layer neurons, this leads to strengthening synapses to form associations. If E2 layer neurons fire before E1 layer neurons, this leads to weakening synapses to wash out noise.

The feedback path (FB) connections exhibit anit-STDP (i.e., aSTDP). If a corrupt or incomplete input appears at the E1 layer, the correct E2 layer neurons should fire. Based on that E2 neuron firing, the full E1 input can be reconstructed. If E1 layer neurons fire before E2 layer neurons, synapses are weakened to remove spurious activity. If E2 layer neurons fire before E1 layer neurons, synapses are strengthened for pattern completion by enhancing connections from inputs seen earlier. The architecture 35 provides a Feed-Forward path with STDP and a Feed-Back path with anti-STDP.

In one example, the WTA process generally models a neuromorphic net of excitatory neurons and an inhibitory neuron. Active excitatory neurons excite the inhibitory neuron. The inhibitory neuron inhibits the excitatory neurons. Activity of the inhibitory neuron increases until most excitatory neurons are inhibited.

FIG. 5B shows an implementation of the architecture 35 of FIG. 5A as system 50, using the architecture 100 in FIG. 1. The system 50 comprises two interconnected cross-bar arrays 12a and 12b using PCM resistors 23, interconnected through neurons 14a, 14b, 16a, 16b, 18a, 18b, 20a and 20b. The interconnected cross-bar arrays 12a and 12b form an associative circuit. In system 50, the E1 layer in the array 12a is shown to include excitatory neurons 14a, 16a, 18a and an inhibitory neuron 20a, wherein the inhibitory neuron 20a represents the I1 layer. Similarly, the E2 layer in the array 12b is shown to include excitatory neurons 14b, 16b, 18b and an inhibitory neuron 20b, wherein the inhibitory neuron 20b represents the I2 layer.

The electronic neurons are interconnected as follows. Each electronic neuron makes a fixed number, M, of outgoing connections with other electronic neurons. Each E1 layer electronic neuron connects to I1 layer and E2 layer electronic neurons. Each I1 layer electronic neuron connects exclusively to E1 layer electronic neurons. Similarly, each E2 layer electronic neuron connects to 12 layer and E1 layer electronic neurons. Each 12 layer electronic neuron connects exclusively to E2 layer electronic neurons. Each pathway connecting any pair of neurons is also assigned a conduction delay. The connections and the delays can be assigned either randomly (e.g., drawn from a distribution) or in a predetermined topographic fashion depending on the intended application. No population is allowed to connect back to itself.

A neuromorphic method and system according to an embodiment of the invention implements features of cortical networks, including spiking neurons, spike-time driven learning rules and recurrent connections between neurons. The system requires only a single spike per neuron to perform input pattern identification and subsequent pattern recall, following an unsupervised training session. The system may serve as an intermediate processing stage of a larger system, wherein a functionally significant amount of processing can occur under time constraints similar to those suggested by neurobiological experiments.

According to an embodiment of the invention, the neuromorphic system implements an architecture configured to accommodate spiking neurons with competitive dynamics and unsupervised learning. The neuromorphic system implements transient neuron assemblies with extinguishing activities as soon as a successful retrieval has been carried out and once the pattern is deactivated. Such transient assemblies allow for an efficient rapid successive activation and retrieval of memories. The neuromorphic system comprises a dedicated neuromorphic circuit for pattern completion with the ability to pinpoint events that require attention and subsequent analysis. The neuromorphic system is readily amenable to incorporation into a modular framework, with each module having the basic two-layer electronic neuron implementation disclosed herein.

As an example, a modular framework construction comprises stacking the basic two-layer modules in a hierarchical fashion, with each level in the hierarchy representing features at varying degrees of abstraction. Additional neuron layers (e.g., E2a, E2b, etc.) may be added to the basic two-layer system, with each neuron layer responding, in parallel, to different pattern features in the same input stream. This can be achieved by using different receptive field profiles for each neuron layer sheet. Alternatively, the system may comprise multiple E1 layers with distinct input streams all feeding into a single E2 layer. The system can consolidate previously-learned patterns into complex composites by taking various permutations and combinations of these alternatives.

The embodiments of the invention can take the form of an entirely hardware embodiment, an entirely software embodiment or an embodiment containing both hardware and software elements. An example architecture of a canonical spiking neuron system according to the invention as described above includes neurons in layers E1, E2, I1 and I2 as well as their connections and learning rules between them. Such a system may be implemented in different ways, such as implementation through simulations on a traditional computer system or through a variety of different hardware schemes, one of which comprises an ultra-dense synapse cross-bar array providing spike-timing dependent plasticity.

The term electronic neuron as used herein represents an architecture configured to simulate a biological neuron. An electronic neuron creates connections between processing elements that are roughly functionally equivalent to neurons of a biological brain. As such, a neuromorphic system comprising electronic neurons according to embodiments of the invention may include various electronic circuits that are modeled on biological neurons. Further, a neuromorphic system comprising electronic neurons according to embodiments of the invention may include various processing elements (including computer simulations) that are modeled on biological neurons. Although certain illustrative embodiments of the invention are described herein using electronic neurons comprising electronic circuits, the present invention is not limited to electronic circuits. A neuromorphic system according to embodiments of the invention can be implemented as a neuromorphic architecture comprising analog or digital circuitry, and additionally as a computer simulation. Indeed, the embodiments of the invention can take the form of an entirely hardware embodiment, an entirely software embodiment or an embodiment containing both hardware and software elements.

Embodiments of the invention can take the form of a computer simulation or program product accessible from a computer-usable or computer-readable medium providing program code for use by or in connection with a computer, processing device, or any instruction execution system. As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

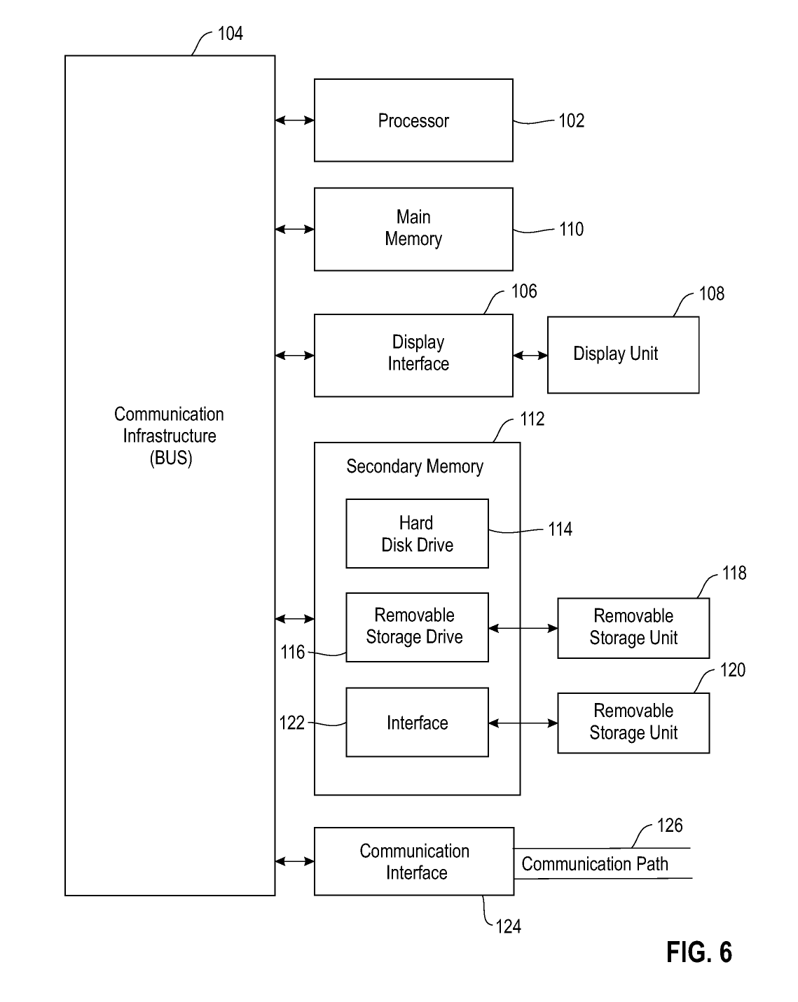

FIG. 6 is a high level block diagram showing an information processing system useful for implementing one embodiment of the present invention. The computer system includes one or more processors, such as a processor 102. The processor 102 is connected to a communication infrastructure 104 (e.g., a communications bus, cross-over bar, or network).

The computer system can include a display interface 106 that forwards graphics, text, and other data from the communication infrastructure 104 (or from a frame buffer not shown) for display on a display unit 108. The computer system also includes a main memory 110, preferably random access memory (RAM), and may also include a secondary memory 112. The secondary memory 112 may include, for example, a hard disk drive 114 and/or a removable storage drive 116, representing, for example, a floppy disk drive, a magnetic tape drive, or an optical disk drive. The removable storage drive 116 reads from and/or writes to a removable storage unit 118 in a manner well known to those having ordinary skill in the art. Removable storage unit 118 represents, for example, a floppy disk, a compact disc, a magnetic tape, or an optical disk, etc., which is read by and written to by removable storage drive 116. As will be appreciated, the removable storage unit 118 includes a computer readable medium having stored therein computer software and/or data.

In alternative embodiments, the secondary memory 112 may include other similar means for allowing computer programs or other instructions to be loaded into the computer system. Such means may include, for example, a removable storage unit 120 and an interface 122. Examples of such means may include a program package and package interface (such as that found in video game devices), a removable memory chip (such as an EPROM, or PROM) and associated socket, and other removable storage units 120 and interfaces 122 which allow software and data to be transferred from the removable storage unit 120 to the computer system.

The computer system may also include a communications interface 124. Communications interface 124 allows software and data to be transferred between the computer system and external devices. Examples of communications interface 124 may include a modem, a network interface (such as an Ethernet card), a communications port, or a PCMCIA slot and card, etc. Software and data transferred via communications interface 124 are in the form of signals which may be, for example, electronic, electromagnetic, optical, or other signals capable of being received by communications interface 124. These signals are provided to communications interface 124 via a communications path (i.e., channel) 126. This communications path 126 carries signals and may be implemented using wire or cable, fiber optics, a phone line, a cellular phone link, an radio frequency (RF) link, and/or other communication channels.

In this document, the terms “computer program medium,” “computer usable medium,” and “computer readable medium” are used to generally refer to media such as main memory 110 and secondary memory 112, removable storage drive 116, and a hard disk installed in hard disk drive 114.

Computer programs (also called computer control logic) are stored in main memory 110 and/or secondary memory 112. Computer programs may also be received via a communication interface 124. Such computer programs, when run, enable the computer system to perform the features of the present invention as discussed herein. In particular, the computer programs, when run, enable the processor 102 to perform the features of the computer system. Accordingly, such computer programs represent controllers of the computer system.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method, comprising:
in response to an electronic neuron spiking, sending a spiking signal from the electronic neuron to each axon driver and each dendrite driver connected to a spiking electronic neuron in a network of electronic neurons;
in response to an axon driver receiving the spiking signal, sending an axonal signal from the axon driver to a variable state resistor, wherein the variable state resistor couples the axon driver to a dendrite driver;
in response to a dendrite driver receiving the spiking signal, sending a dendritic signal from the dendrite driver to the variable state resistor;
wherein the combination of the axonal signal and dendritic signal is capable of changing conductance of the variable state resistor.

2. The method of claim 1, wherein:
sending an axonal signal from the axon driver further comprises sending a first pulse of short duration for communicating forward the spiking signal, and a subsequent elongated second pulse for changing the state of the variable state resistor, wherein the second pulse is longer in duration than the first pulse.

3. The method of claim 2, wherein sending a dendritic signal from the dendrite driver further comprises, after a delay, sending a spike signal of short duration to the variable state resistor.

4. The method of claim 3, wherein sending a dendritic signal from the dendrite driver further comprises sending the spike signal from the dendrite driver midway through the second pulse from the axon driver.

5. The method of claim 4, wherein:
the first pulse from the axon driver is about 0.05 ms to 0.15 ms long;
the second pulse from the axon driver is about 150 ms to 250 ms long; and
the spike signal from the dendrite driver comprises a negative spike signal about 45 ns to 55 ns long that appears about 50 ms to 150 ms after the spiking signal is received.

6. The method of claim 1, wherein:
sending an axonal signal from the axon driver further comprises sending a long programming pulse from the axon driver to a variable state resistor for changing conductance of the variable state resistor, and sending short spikes from the axon driver for communicating the spiking signal from the electronic neuron; and
sending a dendritic signal from the dendrite driver further comprises, after a delay, sending a short programming pulse for increasing or decreasing conductance of the variable state resistor.

7. A neuromorphic system, comprising:
a plurality of electronic neurons;
a cross-bar array interconnecting the plurality of electronic neurons, the cross-bar array comprising:
a plurality of axons and a plurality of dendrites such that the axons and dendrites are orthogonal to one another;
a plurality of variable state resistors, wherein each variable state resistor is at a cross-point junction of the cross-bar array coupled between a dendrite and an axon;
a plurality of dendrite drivers corresponding to the plurality of dendrites, wherein each dendrite driver is coupled to a dendrite at a first side of the cross-bar array; and
a plurality of axon drivers corresponding to the plurality of axons, wherein each axon driver is coupled to an axon at a second side of the cross-bar array;
wherein an axon driver and a dendrite driver, coupled by a variable state resistor at a cross-point junction, in combination generate a signal capable of changing the state of the variable state resistors as a function of time since a last spiking of an electronic neuron firing a spiking signal into the axon driver and the dendrite driver.

8. The system of claim 7, wherein:
the cross-bar array further comprises a plurality of level translators that correspond to the plurality of dendrites, each level translator coupled to one of the plurality of dendrites at a third side of the cross-bar array across the first side of the cross-bar array; and
each electronic neuron is coupled to the cross-bar array via a level translator such that each level translator feeds signals into an electronic neuron and the electronic neuron fires a spiking signal into the axon and dendrite drivers connected to the electronic neuron.

9. The system of claim 8, wherein:
each of the plurality of the variable state resistors at each cross-point junction coupling an axon driver and a dendrite driver changes states by increasing or decreasing conductance as a function of time since a last spiking of the electronic neuron firing a spiking signal into the axon driver and the dendrite driver.

10. The system of claim 9, wherein:
an axon driver generates two output signals in response to a spiking signal from an electronic neuron, a first output signal comprising a first pulse for communicating forward the spiking signal, and a subsequent second output signal comprising a second pulse for changing the state of a variable state resistor at a cross-point junction coupling the axon driver and a dendrite driver, wherein the second pulse is longer in duration than the first pulse.

11. The system of claim 10, wherein the first pulse is about 0.05 ms to 0.15 ms long and the second pulse is about 150 ms to 250 ms long.

12. The system of claim 9, wherein upon receiving a spiking signal from an electronic neuron, after a delay the dendrite driver generates an output signal in response to the spiking signal, wherein the output signal comprises a spike signal.

13. The system of claim 12, wherein the delay is about 50 ms to 150 ms long and the spike signal comprise a negative spike signal about 45 ns to 55 ns long.

14. The system of claim 9, wherein each of the plurality of the level translators translates the amount of input current from a variable state resistor coupled to the level translator, for integration by an electronic neuron coupled to an output of the level translator.

15. The system of claim 7, wherein each variable state resistor comprises a phase change memory synapse device.

16. A neuromorphic system, comprising:
a plurality of electronic neurons having a layered relationship with birectional synaptic connectivity, comprising:
a first excitatory spiking electronic neuron layer comprising a plurality of first excitatory spiking electronic neurons;
a second excitatory spiking electronic neuron layer comprising a plurality of second excitatory spiking electronic neurons; and
a first inhibitory spiking electronic neuron layer comprises at least a first inhibitory spiking electronic neuron;
wherein the first excitatory spiking electronic neuron layer receives an input data stream, and the first and second excitatory spiking electronic neuron layers and the first inhibitory spiking electronic neuron layer, in combination process the received input data stream based on learning rules, wherein the learning rules provide the level of conductance of synaptic interconnections between the plurality of electronic neurons as a function of spatiotemporal input patterns;
wherein the first excitatory spiking electronic neuron layer further comprises a first cross-bar array coupled to the plurality of first excitatory spiking electronic neurons, the first cross-bar array comprising:
a plurality of axons and a plurality of dendrites such that the axons and dendrites are orthogonal to one another;
a plurality of variable state resistors, wherein each variable state resistor is at a cross-point junction of the cross-bar array coupled between a dendrite and an axon;
a plurality of dendrite drivers corresponding to the plurality of dendrites, wherein each dendrite driver coupled to a dendrite at a first side of the cross-bar array; and
a plurality of axon drivers corresponding to the plurality of axons, wherein each axon driver coupled to an axon at a second side of the cross-bar array;
wherein an axon driver and a dendrite driver, coupled by a variable state resistor at a cross-point junction, in combination generate a signal capable of changing the state of the variable state resistors as a function of time since a last spiking of a first excitatory electronic neuron firing a spiking signal into the axon driver and the dendrite driver.

17. The system of claim 16, wherein:
the first cross-bar array further comprises a plurality of level translators that correspond to the plurality of dendrites, each level translator coupled to one of the plurality of dendrites at a third side of the cross-bar array across the first side of the cross-bar array; and
each electronic neuron is coupled to the cross-bar array via a level translator such that each level translator feeds signals into an electronic neuron and the electronic neuron fires a spiking signal into the axon and dendrite drivers connected to the electronic neuron.

18. The system of claim 16, wherein:
the second excitatory spiking electronic neuron layer further comprises a second cross-bar array coupled to the plurality of second excitatory spiking electronic neurons, the second cross-bar array comprising:
a plurality of axons and a plurality of dendrites such that the axons and dendrites are orthogonal to one another;
a plurality of variable state resistors, wherein each variable state resistor is at a cross-point junction of the cross-bar array coupled between a dendrite and an axon;
a plurality of dendrite drivers corresponding to the plurality of dendrites, wherein each dendrite driver coupled to a dendrite at a first side of the cross-bar array; and
a plurality of axon drivers corresponding to the plurality of axons, wherein each axon driver coupled to an axon at a second side of the cross-bar array;
wherein an axon driver and a dendrite driver, coupled by a variable state resistor at a cross-point junction, in combination generate a signal capable of changing the state of the variable state resistors as a function of time since a last spiking of a second excitatory electronic neuron firing a spiking signal into the axon driver and the dendrite driver.

19. The system of claim 18, wherein:
the second cross-bar array further comprises a plurality of level translators that correspond to the plurality of dendrites, each level translator coupled to one of the plurality of dendrites at a third side of the cross-bar array across the first side of the cross-bar array; and
each electronic neuron is coupled to the cross-bar array via a level translator such that each level translator feeds signals into an electronic neuron and the electronic neuron fires a spiking signal into the axon and dendrite drivers connected to the electronic neuron.

20. The system of claim 16, wherein:
each of the plurality of the variable state resistors at each cross-point junction coupling an axon driver and a dendrite driver changes states by increasing or decreasing conductance as a function of time since a last spiking of the electronic neuron firing a spiking signal into the axon driver and the dendrite driver;
an axon driver generates two output signals in response to a spiking signal from an electronic neuron, a first output signal comprising a first pulse for communicating forward the spiking signal, and a subsequent second output signal comprising a second pulse for changing the state of a variable state resistor at a cross-point junction coupling the axon driver and a dendrite driver, wherein the second pulse is longer in duration than the first pulse; and
upon receiving a spiking signal from an electronic neuron, after a delay the dendrite driver generates an output signal in response to the spiking signal, wherein the output signal comprises a spike signal.
